(19) United States
(12) Patent Application Publication
(10) Pub. No.: US 2006/0258401 A1
(43) Pub. Date: Nov. 16, 2006

(54) Radio base station interface

(75) Inventors: Jacob Osterling, Jarfalla (SE); Krzysztof Kaminiski, Tullinge (SE); Lars Skog, Molndal (SE); David Almquist, Jarfalla (SE); Paul Catijn, Enschede (NL)

Correspondence Address: ERICSSON INC., 6300 LEGACY DRIVE, M/S EVR C11, PLANO, TX, 75024, US

(73) Assignee: Telefonaktiebolaget LM Erisson (publ), Stockholm (SE)

(21) Appl. No.: 10/551,940

(22) PCT Filed: Apr. 6, 2004
(86) PCT No.: PCT/SE04/00544

§ 371 Date: Oct. 4, 2005

(30) Foreign Application Priority Data
Apr. 24, 2003 (SE) 0301228-3

(51) Int. Cl. H04B 1/38

(52) U.S. Cl. 455/561

(57) ABSTRACT

The present invention relates to an interface in a Radio Base Station for separating its functionality into a first part, which solely relates to the functionality of the radio network, and a second part, which solely relates to the radio part, i.e. the airborne part of the transmission. The interface provides a minimised bandwidth and comprises one or more user data links for uplink and downlink, a control and supervision link, and a synchronisation link.

### FIELD OF THE INVENTION

The present invention relates to an interface in a radio network unit, e.g. a Radio Base Station as applied in a CDMA-based radio communication system.

### BACKGROUND OF THE INVENTION

Commonly, a Radio Base Station in a radio communication system is responsible for transmitting and receiving data to a certain range of user equipment. On the one hand, this unit takes care of the data handling related to the Radio Network functionality; on the other hand it is responsible for the airborne interface towards said user equipments. Each Radio Base Station covers a certain geographical area and provides various communication services to the user equipments within this area. A Radio Base Station is thus involved into tasks of two different techniques: Communication handling of the Radio Network functionality and handling of airborne interfaces towards user equipments. Both techniques have different requirements and develop at different pace, which is progressed, e.g., due to standardisation activities or due to various customer requirements for the implementation of radio communication networks and imply thus a wide range of products. With regard to the radio related functions still further requirements become necessary due to the location of the Radio Base Station, e.g. in an urban or rural area, and the different demands with respect to radio propagation and traffic capacity that may result from this.

### SUMMARY OF THE INVENTION

Apparently, there is a need to take care of a range of different requirements with regard to the desired or required functionality of the Radio Base Station. This depends on the one hand on the intended use of the Radio Base Station and, on the other hand, on requirements of operators that use such a Radio Base Station and their definition of communication facilities, e.g., in terms of capacity and services or in terms of network design and cell planning. However, a Radio Base Station comprising a high degree of flexibility will most likely involve the problem that changes with respect to any aspect of the Radio Base Station usage will imply an at least potential influence on the entire functionality of the Radio Base Station.

Therefore, it is an object of the present invention to define a suitable interface within a Radio Base Station that separates functionality in such a way that it is possible to adapt the Radio Base Station to various requirements and conditions while, at the same time, the additional complexity of such a Radio Base Station can be kept as minimal as possible.

The object of the present invention is achieved by means of an interface within a Radio Base Station that subdivides the functionality of the Radio Base Station into a first part, which solely relates to the RAN-part and thus the functionality of the radio network, and a second part, which solely relates to the radio part, i.e. the airborne part of the transmission. Further, the internal interface comprises a reduced bandwidth and supports O&M-functionality.

It is a first advantage of the present invention to achieve an interface that is independent of changes in the RAN-part or radio part.

It is a further advantage of the present invention to achieve an interface having a reduced bandwidth.

It is still another advantage of the present invention that the interface can be used for a Radio Base Station concept where the radio part is at a remote location and connected to the RAN-part, e.g., by means of optical fibre.

Other objects, advantages and novel features of the invention will become apparent from the following detailed description of the invention when considered in conjunction with the accompanying drawings and claims.

### BRIEF DESCRIPTION OF THE DRAWINGS

FIG. 1 shows a functional block diagram of an optical link interface.

FIG. 2 shows the organisation of the TX_OIL bitmap to/from a 16-bit parallel interface.

FIG. 3 shows the organisation of the RX_OIL bitmap to/from a 16-bit parallel interface.

### DESCRIPTION OF THE INVENTION

The interface between RAN-part and radio part consists of a plurality of links, which are user data links, a link for O&M-support, and, optionally, a synchronisation link. It is a first demand of the interface according to the present invention that the user data that is transmitted over said interface is independent of any specific requirements for either the RAN-part or the radio part. Instead, the link only transmits the plain user symbols. The solution according to the present invention suggests to transmit user information over the interface as baseband signals comprising digital signal components that describe the air-interface signal. This can be achieved, e.g., by means of transmitting symbols as (I+Q)-components, by means of phase and amplitude components or any other appropriate means.

It is another object of the present invention to reduce the necessary bandwidth of the interface. This is achieved by various means that are described in the following:

Regarding the user link, on the downlink the symbol data is transferred as parallel words at the symbol rate, e.g., 12 bits/symbol at 3.84 Msymbols/second for a WCDMA carrier. For one carrier (I+Q) 92,16 Mbit/s is thus needed. On the uplink the samples are transferred as I and Q components at 2 or 4 times the symbol rate. Each symbol is coded in a floating point format: a 5 bit wide mantissa per component and a common exponent. To save bandwidth, the exponent is not transferred at the symbol rate but on about a millisecond basis. This also allows for an AGC implementation in the radio, where the AGC step is used as basis for the common exponent. For instance, for a WCDMA carrier, if 5 bits are used per component, 4 times oversampling, and the exponent is 6 bits sent every 2 ms (500 Hz), 3.84 Msymbols/s, the total required bandwidth is 5*2*4*3.84M+6*500=153.6 Mbits+3 kbit/s. If two times over sampling is used, the bandwidth decreases to about 77 Mbit/s.

Regarding link supervision, the general fault detection on symbol level is done by means of redundant bits, e.g. parity bits. Each data stream also has its own identity to allow for supervision of routing of the data stream through the RBS. To save bandwidth, the parity bits and stream ID can share bandwidth. This will make some symbols unprotected but this is of less importance, especially on the downlink.

The synchronization link carries three parts: Frequency distribution, time distribution, and interface delay calibration. There is also an associated function delay compensation. Regarding frequency distribution, bandwidth can be saved when the frequency is distributed as the bit clock of the interface, or of a specific link in the interface. Regarding time distribution, a time strobe is transferred over the interface. For a WCDMA system, the time strobe is, e.g., a 10 ms time indicator expressing the frame structure on the Uu-interface. The time the strobe indicates is transferred over the synchronization link or over the O&M link. The time is, e.g., the Node B Frame Number and transferred on its own link. Since the time is distributed on the downlink, from the RAN part to the Radio part, the downlink user data is automatically time stamped and the user data received at the same moment as the time strobe is received is per definition the first sample of that frame. To be able to combine samples in the uplink in the RAKE receiver in an optimal way, the uplink user data shall also carry a time stamp. This is preferably done by marking the first sample in the uplink user data after a downlink time strobe is received.

Interface delay calibration is applied to fine-tune the downlink TX diversity and uplink signal combination (diversity) for which it is essential to know the relationship between different user plane data stream in respect of timing in the air. To know the difference between the time a sample is transmitted from RAN part onto the interface, to the time the sample reaches the air, it is important to know the interface delay, at least in cases of long interfaces, i.e. up to many kilometers. The interface delay is measured by one party transmitting a time strobe and the other party echoing it back to the transmitter. The Radio part, e.g., can echo the time strobe in the downlink time distribution onto the uplink synchronization link, and the RAN part measures the delay until it is received. To further improve the calibration, the Radio Part shall state to the RAN part, over the O&M link, what delay is introduced on the loop of the strobe, as well as what uplink and downlink delay the Radio Part will introduce to the user data on its path between the interface and the Uu interface. To save band width the echoing can use the uplink user data time stamping: The delay through the interface is roughly the time between the frame strobe was sent downlink until the frame strobe is received uplink (via the time stamp). The RAN part can measure this, and it gives an accuracy of the sample rate (a fourth of the symbol rate if 4 times oversampling). A method to further improve the accuracy is to utilize that the uplink user data is fed through a serialiser. The serialiser marks every N:th sample with a sample strobe to allow de-serialisation, and typically every air frame with a double strobe (time stamping). If the serialiser adjusts its sample start to a received downlink frame strobe the accuracy improves to the interface bitrate rather than the sample rate.

Delay compensation: Each Radio Part compensates for its own delay of user data stream UL and DL between the interface and the Uu interface. This is typically implemented by each Radio Part unit that indicates over the O&M link the delay it has on its paths. The RAN part calculates the maximum delay of all UL paths and asks the each Radio Part to introduce a corresponding extra delay to meet the maximum delay. The same is true for the downlink paths. For the downlink, this will ensure that a data symbol put on two different user data streams with equal interface delay at the same time will end up on Uu, i.e. in the air, at the same time. This is essential for Tx Diversity. A more advanced delay compensation also compensates for the difference in interface delays. A similar equalization as described above can be used with extra delay put on either side of the interface (RAN part or Radio part). The basis for the extra delay per interface would be the Interface Delay Calibration outcome. If no Tx Diversity is required the downlink delay compensation can be omitted. If the RAKE receiver window is bigger than the interface delay variations the uplink delay compensation can be omitted. The downlink time strobe can optionally be adjusted to ensure that all Radio parts have the same perception of a frame start. The time strobe is then advanced on the interface according to the measured delay in the Interface Delay Calibration.

The control and supervision link consists of both a processor-processor interface and a low level supervision interface.

The processor-processor link for the communication between software in two processors can use an arbitrary interface, e.g. HDLC or Ethernet.

The low level supervision interface carries functions that should work also in the case of software failures, e.g. in order to help the site engineer to correctly localise the faulty unit. This link is only needed in case of a physically distant mounting of the Radio Part from the RAN part. An opto fiber with laser transmitters is suitable for the communication and is used as example below. A led driven opto-fiber interface or an electrical interface whould have corresponding signals.

Laser monitoring. Three indications are sent on the link to the RAN part: 1) Laser light seen, which indicates that the receiving laser in the Radio Part sees light. This indicates that the fibre at least is not completely broken. 2) Deserialiser locked, which indicates that the quality of the received signal is good enough for the deserialiser of the interface in the Radio Part to synchronise the incoming signal. This indicates that the transmitter in the RAN part is working properly, that the fibre is functional and that the receiver in the Radio Part is working properly. 3) Laser transmitter aging, which indicates that the transmitting laser in the Radio Part has aged and may break in a not to distant future. This indicates that a site engineer should suspect this component if a communication failure occurs. This signal may also be transmitted over the processor-processor link.

Another aspect relates to Radio Part power supervision. This indicator indicates that the incoming power to the Radio Part is functioning. The interface transmitter circuitry of the Radio Part has it own power backup, e.g. a small condensator, to ensure that it lives for a few microseconds after the incoming power to the Radio Part is detected to be missing. This signal condition shall be latched in the RAN part to allow for the site engineer to, interfacing the RAN part, understand that a communication failure with the Radio Part most likely depends on an external power fault at the Radio Part.

Another possibility to save bandwidth is a modified hardware reset functionality. It is desired to have a possibility to reset the Radio Part even when the software of the Radio Part is not functioning. This can be done by sending a hardware reset indication to the Radio Part. To save bandwidth this indication can be sent using a code violation on the processor-processor layer 1 protocol.

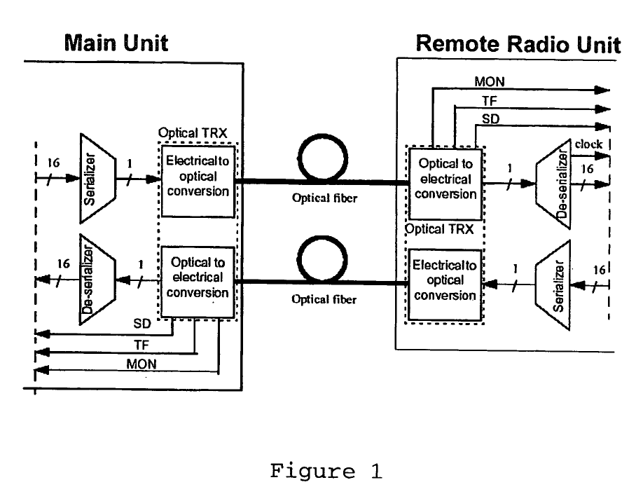

The following describes one possible embodiment of the present invention: FIG. 1 shows a functional block diagram of an optical interface link (OIL). The Optical Interface Link is a digital link between each Remote Radio Unit (Radio part) and the Main Unit (RAN part). The OIL provides channels for the up- and downlink signals (user data link), strobe (time distribution part of the synchronisation link) and control data (O&M link). The system clock is distributed to the RRUs by recovering the clock embedded in the serial signal at the RRU. By the term OIL, all hardware between the 16 bits parallel interface in the Main Unit and the 16 bits parallel interface in the RRU are included. The OIL has to perform the following functionality: Parallel-to-serial and serial-to-parallel conversion and electrical-to-optical and optical-to-electrical conversion The PLD/FPGA connected to the OIL has to perform the following functionality: Supervision of OIL, bitmapping of OIL supervision bits, e.g. parity, signal detect signal, mapping of processor-processor link control bits (layer 3 control).

The user data bits, the bits for the control of the RRU and the clock-signals (frame strobe and BFN) are mapped in a parallel (16 bits) word. This parallel data is serialized, converted to optical and sent over the optical fiber. The system clock is recovered on the RRU from the serial data stream. The mapping of the bits is mostly determined by the number of userdata, control-data and clock-data to be transferred. The TX_OIL is defined as the 16 bit wide parallel interface for communication from the MU to the RRU. The TX_OIL carries strobe, TX user data and control data in direction MU to RRU as well as clock distribution to the RRU. The frame strobe, user data, and control data are transmitted via the 16 bit parallel interfaces of the serializer/deserializer chipset. The clock is distributed with help of the line-code used by the chipset and clock recovery PLL in the deserializer. The strobe and control data occupy one channel each. The other 14 channels are occupied by user data, column parity or not used. Each channel capacity is 30.72 Mb/s.

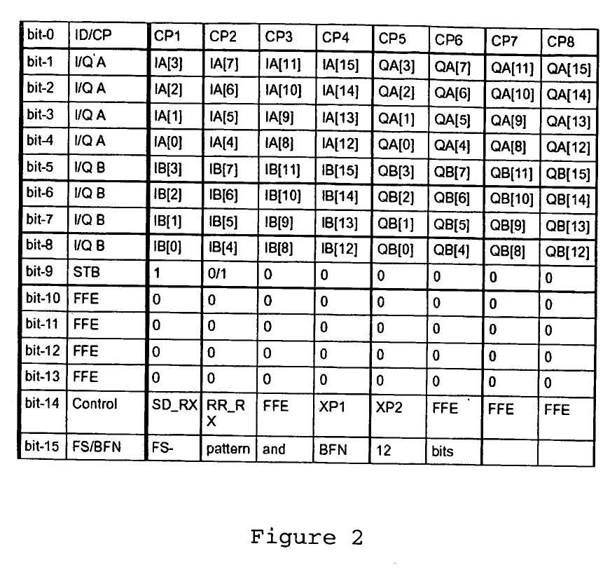

The TX_OIL bitmap is defined in the FIG. 2. User data for two cell carriers are shown, and thus the interface is prepared for TX diversity. Each TX_OIL contains 16 bit parallel data configured as the table above, i.e. 16 bits at 30.72 MHz:
Bit 0 is a column parity bit (odd parity) for bit 1 to bit 15. A User data link identity is also sent over this bit synchronized with the frame strobe on Bit 9.
Bit 1-4 contains I and Q data for TX branch A.
Bit 5-8 contains I and Q data for TX branch B. These bits can be used for TX diversity or second carrier. If not used, these bits are all “0”.
Bit 9 is a strobe. This strobe is 1 every 8 of the parallel word. Once every 10 ms a Frame Sync Mark (time stamp) with two consecutive ones is transmitted.
Bit 10-13 is for future expansion.
Bit 14 is used to transfer control data.
Bit 15 is used for the frame sync (FS) and the BFN. A FS is sent as a logical one every 10 ms then followed by a low/high transition followed by the BFN value, consisting of 12 bits. It is not necessarily synchronous to the strobe on bit 9.

During normal operation, i.e. all PLLs involved in the OIL are locked, the clock distributed to the RRU is exactly synchronous to the system clock in the MU. The serializer on the MU multiplies the system clock of 30.72 MHz, which acts as a parallel to serial clock by a clock multiplier PLL. If locked, the serial clock is frequency synchronous to the system clock. The clock recovery PLL in the deserializer on the RRU recovers the parallel clock from the serial signal with help of the linecode used by the chipset. If locked, the recovered parallel clock is exactly synchronous to the system clock, too. In the Local Timing Unit (LTU) on the TRX board in the RRU, the short term jitter of the recovered clock is removed. As a consequence, the recovered clock in the RRU refined by the LTU is a replica of the system clock in the MU.

Bit 0 of the TX_OIL interface transfers the column parity calculated over bit 1 to bit 15. Once every 10 ms a frame strobe with two consecutive ones is transmitted on bit 9 strobe. When frame strobe is transmitted, the User Data Link IDs are transmitted on Bit 0 ID/CP instead of the column parity signal. The User Data Link IDs identifies the cell-carrier-branch which are transmitted over the link. Normal data transmission is continued on the other OIL bits during frame strobe.

Bit 14 of the TX_OIL interface transfers both hardware flags and software control data. This bit is divided in to 8 separate control channels of 3.84 Mb/s each in a way that each channel is sent every 8 bit. The fourth bit of every eight bits, XP1, contains the processor-processor link with the RRU. The fifth bit of every eight bits is reserved, XP2, contains the processor-processor communication with the Remote Electrically Tilt Anteanna (RET) and any other auxiliary units connected to the RRU (e.g. TMA if used). The rest of the bits can be used for other control signals and future enhancements.

The RX_OIL is defined as the 16 bit wide parallel interface for communication from the RRU to the MU. The bit map on the RRU side and the MU side are identical. The RX_OIL carries strobe, uplink user data and control data in direction RRU to MU. The strobe, uplink user data and control data are transmitted via the 16 bit parallel interfaces of the serializer/deserializer chipset. The strobe and control data occupy one channel each. The other 14 channels are occupied by user data, AGC/ID data or not used. The channel capacity is 30.72 Mb/s. The transmission of the 16 bit data is as follows: the 16 bit data is serialized, converted to optical, send over optical cable and jumper cable to the MU, where it is converted back to electrical and deserialized, recovering the original 16 bit data.

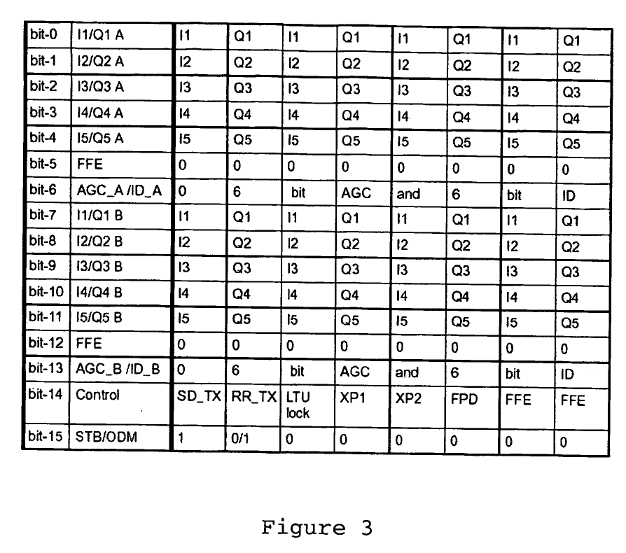

The RX_OIL bitmap is defined in FIG. 3. It contains two carriers I&Q signals, thus providing for RX diversity. The I&Q data is oversampled four times. This improves reliability of data and provides for some margin for data coming in to the searcher alignment window in the RAKE receiver in the MU. Each RX_OIL contains 16 bit parallel data configured as the table above, 16 bits at 30.72 MHz:
Bit 0-4 contains I and Q data for RX branch A (I5,Q5 are MSB, I1,Q1 are LSB).
Bit 5 is a column parity bit (odd parity) for bit 1 to 4 and bit 6 to 15.
Bit 6 contains a 6 bit AGC-value followed by a 6 bit ID value for branch A. AGC and ID are sent synchronized with the FS period of 10 ms.
Bit 7-11 contains I and Q data for RX branch B (I5,Q5 are MSB, I1,Q1 are LSB).
Bit 12 is for future expansion.
Bit 13 contains a 6 bit AGC-value and a 6 bit ID value for branch B. AGC and ID are sent synchronized with the FS period of 10 ms.
Bit 14 is used to transfer control data.
Bit 15 is a Strobe. This strobe is 1 every 8 of the parallel word, except for the FS duration when there is a double 1, the Frame Sync Mark. The Frame Sync Mark is generated by the time stamp function in receiver using the FS/BFN from TX_OIL. The Frame Sync Mark is also used for the delay calibration function.

The cleaned clock from the LTU is used to clock the serializer in the RRU. The clock multiplier PLL in the serializer generates a serial clock and the clock recovery PLL in the deserializer in the MU recovers the parallel clock. In this way the clock distributed to the RRU and back to the MU transduces five PLL stages. If all PLL stages are locked, the recovered parallel clock on the MU is exactly synchronous to the system clock and has a constant phase shift due to the signal delays through the link system. However, the recovered clock in the MU is a more jittery replica of the system clock. Thus the system clock need to be used only, the recovered clock is only used internally by the deserializer.

Bit 6 and bit 13 contains a 6 bit AGC-value and a 6 bit ID value for each branch. Bit 6 relates to branch A and bit 13 relates to branch B. The AGC values are sent synchronized with the FS period of 10 ms. In front of the AGC value a ‘0’ is sent. The AGC values are sent once every third slot period. A 6-bit user data link ID value for connection supervision is sent directly after the respective AGC-value.

Bit 14 of the RX_OIL interface transfers control flags and the processor-processor interface communication. This bit is divided into 8 separate control channels of 3.84 Mb/s each in a way that each channel is sent every 8 bit. The first bit of every eight, SD_RX, indicates that the TX_OIL laser receiver (in the RRU) sees light. The second bit of every eight, RR_RX, indicates that the TX_OIL laser deserialiser (in the RRU) is locked and functioning. The fourth bit of every eight bits, XP1, contains a bit for the processor-processor communication between the MU and the RRU. The fifth bit of every eight bits, XP2, contains a bit for processor-processor communication between the MU and any auxiliary units connected to the RRU (like RET). The sixth bit of every eight bits, FPD contains a Fast Power Down bit of the RRU, This bit can be used to send a fast alarm that the RRU looses its power The bit has to be 5 times successively activated in order to be seen as an alarm. The rest of the bits can be used for other control signals.

1. An interface in a Radio Base Station for transmission and reception of user data to and from one or more user equipments in a radio communication network, comprising:
a plurality of links having a minimised bandwidth for carrying data independent of the functionality of the radio access network and the airborne radio transmission,

2. The interface according to claim 1 comprising one or more user data links for uplink and downlink, a control and supervision link, and a synchronisation link.

3. The interface according to claim 1 intended for carrying baseband signals comprising digital signal components that describe the airborne signal.

4. The interface according to claim 3 wherein the user data link transferes the downlink user data as symbols and the uplink user data as sampled symbols.

5. The interface according to claim 2 wherein the user data link carries information about stream identity for routing and/or supervision.

6. The interface according to claim 2 wherein the control and supervision link is split between a processor based link and fast indications.

7. The interface according to claim 6 wherein the fast indications are used to determine the status of the radio transmission part when the processor based link has failed.

8. The interface according to claim 6 wherein an indication is used to reset the radio transmission part.

9. The interface according to claim 2 wherein the synchronisation link is used to control the transmission time of the user data link.

10. The interface according to claim 2 wherein the synchronisation link is used to time stamp the reception time of the user data link.

11. The interface according to claim 6 wherein a hardware reset is encoded in the processor based link layer 1 protocol as a code violation.

12. The interface according to claim 5 wherein transmission of parity bits is suspended during stream identity transmission.

13. The interface according to claim 4 wherein the uplink data format consists of a fast changing mantissa and a slow changing exponent.

14-15. (canceled)

16. The interface according to claim 2 where the uplink interface serialiser is controlled by the synchronisation link.
